(19) United States
(12) Patent Application Publication
(10) Pub. No.: US 2012/0081366 A1
(43) Pub. Date: Apr. 5, 2012

(54) ASSEMBLY FOR THE SELECTIVE THREE-DIMENSIONAL OR TWO-DIMENSIONAL REPRESENTATION OF IMAGES

(76) Inventors: Wolfgang Tzschoppe, Jena-Rothenstein (DE); Markus Klippstein, Jena-Munchenroda (DE); Thomas Bruggert, Jena (DE)

(21) Appl. No.: 13/324,182

(22) Filed: Dec. 13, 2011

Related U.S. Application Data
(63) Continuation of application No. 11/662,686, filed on Feb. 25, 2008, now abandoned.

(30) Foreign Application Priority Data
Sep. 13, 2004 (DE) 10 2004 044 802.7

(51) Int. Cl. G06T 15/00

(52) U.S. Cl. 345/419

(57) ABSTRACT

An assembly for two or three dimensional image representation having an image reproduction unit, a first scattering layer located behind the image reproduction unit in the line of vision of a viewer, a filter array located behind the image reproduction unit and the first scattering layer in the line of vision of a viewer, and a second scattering layer located in front of and directly on the image reproduction unit in the line of vision of the viewer. The first scattering layer has a plurality of image elements, which in a predetermined allocation represent information from one or more views of a scene, object or text and can be switched back and forth between a transparent condition and a scattering condition.

### CROSS-REFERENCE TO RELATED APPLICATIONS

The present application is a continuation of U.S. Non-Provisional patent application Ser. No. 11/662,686 entitled “Assembly For The Selective Three-Dimensional Or Two-Dimensional Representation Of Images” filed by the present inventors on Feb. 25, 2008.

The aforementioned non-provisional patent application is hereby incorporated by reference in its entirety.

### BACKGROUND OF THE INVENTION

1. Field of the Invention

The present invention relates to an assembly for the selective three-dimensional or two-dimensional representation of images.

2. Brief Description of the Related Art

A multiplicity of methods and assemblies has been developed during the course of research in the field of automatic stereoscopic display, which convey spatial impressions to one or more observers without the need for ancillary equipment. However, these assemblies often only permit a limited representation of ordinary text or two-dimensional images, as is the case e.g. with U.S. Pat. Nos. 4,457,574 and 5,606,455. And yet it is a great advantage for the user if he can selectively switch over from a magnifier-free 3-D display to a high-resolution 2-D presentation which is largely unimpaired, on one and the same device.

Electronically actuated color LCD panels, which are also suitable for the display of two-dimensional images in the traditional manner of actuation, are used among other things for the optical representation of aspects of an object in automatic stereoscopic replication. In many applications, there is a considerable amount of interest in being able to switch over from an automatic spatially stereoscopic presentation (which in the following is also called a three-dimensional display, on account of the strong spatial impression), to a two-dimensional presentation. This has particular relevance for the legibility of texts, since the image quality is better in the two-dimensional mode of operation because of higher image resolution.

A range of assemblies are known with regard to such a switch-over from 2-D to 3-D, and vice versa. Thus the specification WO 01/56265 describes a method for spatial representation in which at least one wavelength filter array provides a display that may be perceived to be spatial. In a special embodiment of this invention, an LCD panel functions as a wavelength filter array with a variable degree of transmission. This facilitates a switch-over between a 2-D and a 3-D representation. To be sure, the disadvantage here is that the light has to penetrate through two LCD panels, i.e. through a variety of components such as polarization filters, liquid crystal layers and further components such as carrier substrates, with the result that brightness is reduced both in the 2-D as well as the 3-D displays.

In U.S. Pat. No. 6,157,424 a 2-D/3-D display is described in which two LCD panels are connected in series and one of them serves as a barrier that can be switched on.

The specification WO 02/35277 describes a 3-D display having a substrate that contains bands with a first set of optical characteristics and intermediate layers with a second set of optical characteristics, as well as a polarizer. As a result of this, the 2-D/3-D changeover is enabled by rotation of polarization, or the addition or omission of a polarizer.

A 2-D/3-D display that can be switched over is likewise described in U.S. Pat. No. 6,337,721. This arrangement provides for several light sources, one lenticular unit and at least one key dispersing disk that can be switched on. These components ensure the provision of different illumination modes in order to achieve a 2-D or a 3-D display, respectively.

U.S. Pat. No. 5,897,184 discloses an automatic stereoscopic display with an illumination component of reduced thickness for portable computer systems, which enables zonal switching from 3D to 2-D presentation and vice versa. The disadvantage of this is that it is a two-channel 3-D display unit for only one observer who, in addition, has to take up a fixed position in order to make observations.

Moreover, the image brightness in the 3-D mode is less than comparable two-channel displays. This applies to those 3-D displays which represent exactly a left-hand image and exactly a right-hand image. Furthermore, strong and disruptive moire effects are noticeable, if the observation positions chosen prior to the 3-D display are incorrect in their depth. In the 2-D mode, the amount of light available is dispersed for the 3-D mode, among other things, with the aim of abolishing the 3-D image separation by homogenization of the illumination. Hence the image brightness is reduced in the 2-D mode in the case of assemblies with a switchable dispersing disk, as the dispersion state of such dispersing disks exhibits a transmission level that is smaller than 1 (for example, 50%). By the way, the device can only be manufactured at a high production engineering cost. A further disadvantage is that the insertion of a switchable dispersing disk increases the distance between the illumination component and the image replication panel, which in particular prevents normal viewing distances in the case of 3-D displays with small pixel ratings and/or a high resolution.

U.S. Pat. No. 5,134,345 describes an illumination system for high-resolution and 3-D displays which to begin with generates certain illumination patterns in time sequence (stroboscopically). A further embodiment for the achievement of a 2-D/3-D display envisages a dispersing disk which changes over from a transparent mode to a dispersion mode and which switches over to dispersion for the 2-D mode.

Moreover, U.S. Pat. No. 5,500,765 describes how the effect of a lenticular unit can be cancelled out if a complementary lens arrangement is folded over it. This virtually switches off the 3-D display. The add-on operates only with lenticular systems and requires the production of an exactly complementary lens arrangement. Further disadvantages are sensitivity to dust and increased reflection losses.

German patent DE 100 53 868 C2 describes an arrangement for selective 2-D or 3-D display with two light sources, whereby the 3-D illumination is always switched off for the 2-D display, or the light radiated from it is blocked. The disadvantage here is that the 2-D light cannot be made sufficiently homogeneous with respect to the luminous density of the illumination.

Furthermore, when introducing a commercially available fiber-optic light guide as 2-D illumination, the macroscopic structure becomes visible to the observer or observers and a troublesome pattern emerges. However, a microscopic structuring that is not visible is elaborate and expensive to manufacture.

Specification JP 10268805 set itself the task of achieving a bright 2-D image as well as the same brightness for 2-D and 3-D displays. In order to achieve this, it employs a lenticular screen as a luminosity barrier, which is located behind an image transducer. Furthermore, a weakly dispersing disk is movably mounted for temporarily cancelling the effect of the lens.

The inherent disadvantage here is that a light source for parallel directional light is necessary so that, strictly speaking, no 3-D observation space can exist, but solely a single, fixed observation position. Moreover, a complicated fiber-optic light guide is needed for parallel light radiation in the side light mode that is employed. Likewise, a complicated and expensive side light would also be needed with any additional parallelization structure on the decoupling side opposite, i.e. for the area of the fiber-optic light guide on the observation side. For example, with oblique parallel illumination, the foci would not lie within one diffuser plane because of the optical lenticular process. Consequently, blurring would occur in varying degrees during the 3-D display, particularly in the case of oblique viewing.

According to the U.S. Patent Application Publication No. 2003/0011884, a 3-D/2-D switchover is provided with diffusing means. The 3-D/2-D display comprises additional converting means, in contrast to a plain 3-D display. These “converting means” constitute “the second condition”, which is intended to mean the 2-D mode, and comprise diffusing means which should bring about a 2-D display in various ways.

A disadvantage of this arrangement is that the resolution is very bad in the 2-D mode and that full resolution is not attained in the 2-D mode. Consequently, the text displayed in the 2-D mode remains illegible, for example.

According to the assemblies depicted in FIG. 9 and FIG. 10 of U.S. Patent Application Publication No. 2003/0011884 A1, which features a switchable scattering layer 94 within a lenticulation 15, the optical distance between the scattering layer and the sub-pixels is indeed smaller, but still remains relatively high. Such a lenticulation is, moreover, difficult and expensive to manufacture and has further disadvantages on account of the additional switchable dispersing properties. The ambient light suitability of conventional 2-D displays is likewise not achieved.

Lenticulation is also preferred for image separation in the specification WO 99/44091. Hereby, an image-separating lenticulation serves as a light-scattering component by approximating the image transducer. The lenticulation itself is formed neither at its convex or planar surface, nor is its interior light-scattering. The scattering effect is supposed to take place within the lenticulation itself. The scattering layer thereby has a finite spacing from the image transducer and a virtual spacing of 0 mm from the image separator. Consequently, the scattering layer must degrade the 2-D image on the image transducer and cannot cancel the lenticular image-separating effect. As a result, the text presented with these assemblies in 2-D mode also remains illegible; moreover, the ambient light suitability of conventional 2-D displays is not attained.

### SUMMARY OF THE INVENTION

Proceeding from this, it is the aim of the present invention to create an assembly of the aforesaid type that can be realized with simple means. The assembly should simultaneously provide several observers with a spatially perceptible image, without using ancillary equipment. It should be possible to display a high-resolution image, and most preferably a full-resolution image, in the 2-D mode. Furthermore, the image replication device that is the subject of this invention should also be able to satisfy the usual 3-D observation intervals even with a high resolution. Moreover, assemblies made according to the invention should exhibit the same ambient light suitability as is customary for 2-D displays of the same brightness.

In accordance with the invention, this aim is achieved by an assembly for the selective three-dimensional or two-dimensional representation of images, comprising an image replication device with a multiplicity of image elements which in a predetermined order represent information from one or several aspects of a scene/an object/a text, a filter array positioned behind the image replication device and in the line of sight of a viewer, which comprises a multiplicity of wavelength filter elements that are permeable in specific wavelength zones, a first scattering layer positioned in the line of sight of the viewer, behind the image replication device and in front of the filter array, which can be switched from a transparent state and a dispersing state, a second scattering layer in the line of sight of a viewer, in front of and directly on the image replication device, which in a preferred embodiment of the invention comprises an anti-glare matting material. The filter elements are arranged in such a manner that defined directions for scattering are pre-determined for the light radiated from the image replication device in the transparent condition of the first scattering layer, which are largely uninfluenced by the second scattering layer, so that a multiplicity of first observation points largely or exclusively register information from a first group of aspects, and a multiplicity of second observation points largely or exclusively register information from a second group of aspects, and the structuring of the light penetrating through the filter array in the dispersing state of the first scattering layer is reduced with respect to the first state.

In the given arrangement, the image replication device represents information from several aspects of a scene/an object/a text, if the first scattering layer is in the transparent state (3-D mode). But if in contrast to this, the first scattering layer is in the dispersing state, the image replication device provides data from one aspect of a scene/of an object/of a text (2-D mode).

The image replication device may be an LCD display panel, and preferably a colour LCD panel. On the other hand, light transmittance can also be put to use in image replication devices.

The above-mentioned first group and second group of aspects may in each case comprise one or several perspectives. Accordingly, at one viewing location, for example, information is made visible exclusively to one eye on one aspect, or information that is largely about one aspect (e.g. to more than 60 percent, while the remaining 40 percent of information stems from one or several additional aspects). However, it is also possible for information to be made visible exclusively from two aspects, or largely as two perspectives when accurately viewed from one observation point. As the viewer has his eyes positioned at different viewing points, he therefore regularly perceives information from different groups of aspects, which enables him to gain a three-dimensional impression. The same thing applies to any further viewers who may be involved.

By way of contrast, the structuring of light penetrating through the filter array, with the first scattering layer in the dispersing state, is reduced with respect to the first state, and preferably beneath the contrast threshold for human sight, so that a two-dimensional image and/or full resolution text presented now is visible. According to the invention, the second scattering layer, which preferably exhibits an anti-glare matting, amplifies the aforesaid scattering effect in the line of sight of the viewer, directly on the image replication device, in this dispersing state. This characteristic of the assembly according to the invention has several advantages. For one thing, less demand need be made on the first scattering layer (in its dispersing state), i.e. solely a reduced haze value is necessary when compared with (notional) assemblies which are not provided with a second scattering layer.

However, the distance between the filter array and the first scattering layer can also be reduced (with undiminished first scattering layer haze in the scattering state), as the second scattering layer once again abolishes (disperses) any residual visibility of the filter array structure that may possibly occur because of the aforesaid reduction in spacing. Hence a lower structural depth of the assembly and also a smaller distance of the filter array from the image replication devices are possible. The latter is particularly advantageous if the usual viewing distances are to be realized with high-resolution image replication devices for the 3-D presentation.

For special embodiments of the invention, it is also conceivable that the second scattering layer be located in an optical path in one place, e.g. between the first scattering layer and the image replication device, and not attached at the front and on the image replication device.

The filter array is preferably designed as a passive filter, e.g. as an exposed and developed photographic film, or else as a printed colour. The individual filter elements of the filter array hereby exhibit a random contour, which is preferably rectangular one. For example, the filter array may be applied (laminated, printed) onto a transparent substrate.

In a preferred embodiment of the invention, the filter array contains exclusively such filter elements that are either opaque or transparent in the visible light spectrum.

In the assemblies according to the invention, a lighting instrument is located behind the filter array in the line of sight of the viewer and radiates light in a laminar fashion. Preferably, the brightness of the lighting instrument can be altered as far as possible between two values. Hence it is possible, for example, to set the brightness at a lower value (e.g. 50% in relation to the luminous density of the bank of lamps) during the transparent state of the first scattering layer, than during the dispersing state for the first scattering layer.

This has the advantage that the image displayed to the viewer or viewers is of about the same brightness in both first layer states. The necessity of such a measure for changing the brightness arises from the fact that a spatial concentration of light occurs with different films (e.g. the Brightness Enhancement Film marketed by 3M) in many lighting instruments, which when in the dispersing state (but not in the transparent state) largely destroys the first scattering layer. This destruction of the spatial light concentration is accompanied by a reduction in average luminosity, since the available light is then distributed over a larger spatial angle.

In a preferred embodiment of the invention, the first and second scattering layers are spaced at an unchanging and definite distance from each other. Hence, the first scattering layer may be attached to the rear side of an LCD panel, for example (which corresponds to the image replicating device), and the second scattering layer may be attached as a traditional anti-glare matting to the front side of the aforesaid LCD panel. Consequently, the spacing of the two scattering layers with respect to each other is approximately the thickness of the LCD panel. The first scattering layer may, for example, be a PDLC film (manufacturer: Innoptec Rovereto, Italy).

Moreover, it is advantageous if the assembly according to the invention also incorporates a control electronics unit that switches the first scattering layer to the transparent state or to the dispersing state in response to an electronic or electrical input signal, respectively. This virtually enables the assembly to switch automatically to the corresponding-mode (2-D) or 3-D), depending on the 2-D or 3-D image content to be displayed. Hence it is possible, for example, for a 1-bit control signal (e.g. plus or minus 6 volts, 0 or 12 volts) to be transmitted to such a control electronics unit from a computer that simultaneously generates the images to be displayed, via a serial output. For example, if the high level applies, the first scattering layer is displaced in the dispersing state; if the low level applies, the first scattering layer is put in the transparent state.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a schematic diagram of an assembly according to a preferred embodiment of the present invention.

FIG. 2 is a schematic diagram of an assembly according to a preferred embodiment of the present invention, wherein the first scattering layer here is in the transparent state.

FIG. 3 is a schematic diagram of an assembly according to a preferred embodiment of the present invention, wherein the first scattering layer is in the dispersing state.

### DETAILED DESCRIPTION OF THE PREFERRED EMBODIMENTS

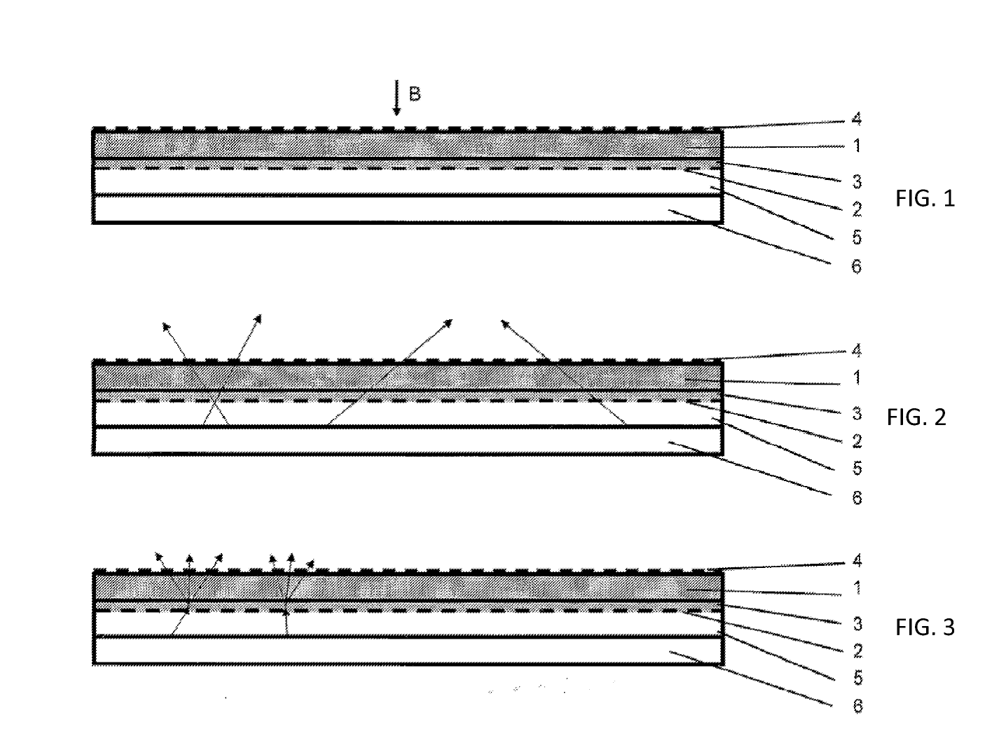

FIG. 1 illustrates the assembly according to the invention for the selective three-dimensional or two-dimensional representation of images, as a schematic diagram. The assembly comprises an image replicating device 1 with a multiplicity of image elements which in a predetermined co-ordination represent information from one or several aspects of a scene/of an object/of a text, a filter array 2 located behind the image replicating device 1, in the line of sight B of a viewer, which comprises a multiplicity of wavelength filter elements that are permeable to specific wavelength ranges, a first scattering layer 3 located behind the image replicating device 1 and in front of the filter array 2, in the line of sight B of the viewer, which can be selectively switched between a transparent state and a dispersing state, a second scattering layer 4 positioned in front of and directly on the image replicating device 1, in the line of sight of the viewer, which preferably corresponds to an anti-glare matting, wherein the filter elements are arranged in such a way that specific directions of dispersion are allowed for the light radiated from the image replicating device 1 when the first scattering layer 3 is in the transparent state, which are largely uninfluenced by the second scattering layer 4 so that data on a first group of aspects are mainly or exclusively discernible at a multiplicity of first viewing places, and data on a second group of aspects are mainly or exclusively discernible at a multiplicity of second viewing places, and the structuring of light passing through the filter array 2 is reduced with respect to the first state, with the first scattering layer 3 in the dispersing state.

Furthermore, FIG. 1 shows a transparent glass substrate 5 on which the filter army 2 is attached. Moreover, an illumination device 6 is positioned behind the filter array 2, in the line of sight B of a viewer, which radiates light in a laminar fashion. Preferably, the brightness of the lighting instrument 6 can be altered between at least two values. This enables the brightness to be set at a lower value (e.g. 50% with respect to the laminar luminous density) during the transparent state of the first scattering layer 3, than during the dispersing state of the first scattering layer 3.

The image replicating device 1 relates, for example, to an LCD panel such as the Viewsonic VX900 TFT-LCD panel that is commercially available. The 3-D mode of operation for the assembly is illustrated in FIG. 2. The flat beam of light radiated from the lighting instrument 6 is structured by the filter array 2 and also passes through the first scattering layer 3 in its transparent state, virtually without being influenced, and then through the image replicating device 1 and the second scattering layer 4. This image replicating device 1 represents a predetermined sequence of data from several aspects of a scene/an object/a text, when the first scattering layer 3 is in the transparent state (3-D mode).

On the structure of the filter array 2 to be employed, reference is made here representatively to the specifications DE 201 21 318 U1, WO 01/56265, PCT/EP2004/004464, PCT/UP2004/001833 as well as DE 101 45 133 filed by the applicant. Naturally, it is taken for granted that the allocation of data from one or several aspects of a scene/an object/a text must be made in a suitable manner with respect to the multiplicity of image elements, particularly in accordance with instructions obtained from one or several of the aforementioned publications.

But if, on the other hand, the first scattering layer 3 is in the dispersing state, then the image replicating device 1 represents information from just one aspect of a scene/an object/a text (2-D mode). In the dispersing state of the first scattering layer 3 now, the structuring of light passing through the filter array 2 is reduced with respect to the first state, and is preferably under the contrast threshold for human sight so that a two-dimensional image is displayed now and/or a text is visible in full resolution. A second scattering layer 4 positioned directly on the image replicating device 1 takes effect during this scattering condition of the first scattering layer 3, in the line of sight of a viewer, which corresponds to an anti-glare matting and in accordance with the invention acts as an amplifier of the aforesaid scattering effect. This property of the assembly, in accordance with the invention, has several advantages. On the one hand, the demand made on the first scattering layer 3 (in its dispersing state) can be reduced, i.e. solely a reduced haze value is needed in comparison with (notional) assemblies that do not have a second scattering layer 4.

However, the spacing between the filter array 2 and the first scattering layer 3 can be reduced (with undiminished haze of the first scattering layer in the dispersing state), since the second scattering layer 4 once again abolishes (disperses) any residual visibility of the filter array structure 2 that may occur because of the aforesaid reduction of spacing. This makes it possible for the assembly to have a low-depth structure as well as closer spacing of the filter array 2 from the image replicating device 1. The latter is particularly advantageous if the usual viewing distances for 3-D displays are realized with high-resolution image replicating devices 1.

The filter array 2 is preferably designed as a passive filter. e.g. as an exposed and developed photographic film, or else as printed color. Accordingly, the individual filter elements of the filter array 2 exhibit a random contour which is preferably rectangular. For example, the filter array can be attached to a transparent substrate (laminated, printed, etc.)

In a preferred embodiment of the invention, the filter array 2 contains exclusively such filter elements that are either opaque or transparent within the overall spectrum of visible light.

The first and second scattering layers 3,4 are positioned so as to be spaced at a constant, definite distance from each other. Accordingly, the first scattering layer 3 is attached directly on to the rear side of an LCD panel (which corresponds to the image replicating device 1) and the second scattering layer 4 is attached to the front side of the aforesaid LCD panel as a traditional anti-glare matting. The spacing between the two scattering layers 3, 4 roughly corresponds to the thickness of the LCD panel. The first scattering layer, for example, is a PDLC film (manufacturer: Innoptec Rovereto, Italy).

The assembly according to the invention also comprises a control electronics unit (not shown in the diagram), which switches an electrical input signal to the first scattering layer 3 in the transparent state, or in the scattering state, respectively. This makes it possible for the assembly that is the subject of this invention to be switched virtually automatically into the corresponding mode (2-D or 3-D), depending on the image content (2-D, or 3-D images). Thus a computer that simultaneously generates the images to be presented transmits a 1-bit control signal (e.g. plus or minus 6 volts, 0 or 12 volts) to the control electronics unit via a serial output. If a high level is indicated, then the first scattering layer 3 is put in the dispersing state; if a low level is indicated, the first scattering layer is put in the transparent state.

The present invention has a number of advantages to offer. First of all, an assembly of the above-mentioned type can be manufactured using simple means, or to be more precise, almost exclusively with ordinary commercial components. Moreover, the principle underpinning the invention facilitates the creation of 2-D/3-D screens which even at high resolution of the image replicating unit on which they depend, provide the customary 3-D viewing distances. Furthermore, the demands placed on the first scattering layer are reduced in each case. Over and above this, the assembly according to the invention achieves the same ambient light suitability as the customary 2-D displays of the same brightness when the second scattering layer is designed as anti-glare matting.

1. Assembly for the selective three-dimensional or two dimensional representation of images, comprising:
an image replicating means with a multiplicity of image elements which represent information from one of several aspects a scene in a predetermined allocation;
a filter array behind the image replicating means in the line of sight of a viewer, said filter array comprising a multiplicity of wavelength filter elements that are permeable in certain wavelength ranges;
a first scattering layer located behind the image replicating means and in front of the filter array, in the line of sight of a viewer, said first scattering layer being selectively switchable between a transparent state and a dispersing state, wherein said first scattering layer is attached directly on the rear side of the image replicating means;
a second scattering layer positioned in the line of sight of a viewer in front of and directly on the image replicating means, said second scattering layer comprising an anti-glare matting acting as an intensifier for the dispersing effect of the first scattering layer;
whereby said wavelength filter elements are arranged in such a manner that:
with the first scattering layer in the transparent state, definite and predetermined directions of spreading are set for the light radiated from the image replicating means, which are largely uninfluenced by the second scattering layer so that information from a first group of aspects is mainly or exclusively perceptible at a multiplicity of first viewing places, and information from a second group of aspects is mainly or exclusively perceptible at a multiplicity of second viewing places; and
with the first scattering layer in the dispersing state, structuring of the light passing through the filter array is diminished to one aspect of said scene, and wherein the filter array is designed as a passive filter.

2. The assembly according to claim 1, wherein said passive filter comprises printed color.

3. The assembly according to claim 2, wherein the passive filter is an exposed and developed photographic film.

4. The assembly according to claim 1, wherein the filter array exclusively features filter elements that are either opaque or transparent in the overall spectrum of visible light.

5. The assembly according to claim 1, wherein the filter array filter array is applied onto a transparent substrate.

6. The assembly according to claim 1, further comprising a lighting instrument located behind the filter array in the line of sight of the viewer, wherein said lighting instrument radiates light in a laminar fashion.

7. The assembly according to claim 6, wherein a brightness of said lighting instrument can be altered between two values.

8. The assembly according to claim 6, wherein a brightness of said lighting instrument is set at a first value during the transparent state of the first scattering layer and a second value during the dispersing state of the first scattering layer, wherein said first value is lower than said second value.

9. The assembly according to claim 8, wherein said first value is approximately 50% of said second value.

10. The assembly according to claim 1, further comprising a control electronics unit, wherein said control electronics unit switches the first scattering layer to one of the transparent state or the dispersing state in response to an electrical input signal.

11. The assembly according to claim 1 wherein said scene comprises an object.

12. The assembly according to claim 1 wherein said scene comprises text.
